(19) United States
(12) Patent Application Publication
(10) Pub. No.: US 2009/0066465 A1
(43) Pub. Date: Mar. 12, 2009

(54) MAGNETIC CORE FOR TESTING MAGNETIC SENSORS

(76) Inventors: Udo Ausserlechner, Villach (AT); Michael Holliber, Keutschach (AT)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/850,851

(22) Filed: Sep. 6, 2007

(51) Int. Cl. H01F 27/245; B44C 1/22

(52) U.S. Cl. 336/212; 216/22

(57) ABSTRACT

A magnetic core for testing a magnetic sensor includes a base portion, and first, second, and third legs extending from the base portion. At least one coil generates magnetic flux through the magnetic core and into the magnetic sensor. The base portion and the first, second, and third legs are formed as a single piece without bonding joints therebetween.

### BACKGROUND

Some magnetic speed sensors are configured to measure the speed of a magnetic tooth wheel. Such speed sensors typically include an integrated circuit with a plurality of magnetic sensor elements, such as Hall sensor elements or xMR sensor elements (e.g., GMR—giant magneto resistance; AMR—anisotropic magneto resistance; TMR—tunnel magneto resistance; CMR—colossal magneto resistance). A permanent magnet provides a bias magnetic field to the sensor elements. As the wheel is rotated, the teeth of the wheel pass in front of the sensor and generate a small field variation, which is detected by the integrated circuit. The detected field contains information about the angular position and rotational speed of the wheel.

It is desirable to be able to test magnetic sensors, such as magnetic tooth wheel speed sensors, to help ensure that the sensors are operating properly. One method for testing a magnetic sensor is to use a magnetic core to apply test magnetic fields to the sensor, and measure the sensor response. Typically, different magnetic cores are used depending upon the type of magnetic sensor being tested (e.g., Hall or xMR).

Prior magnetic cores used for testing magnetic sensors have included three legs (e.g., a center leg and two outer legs), with a coil winding wrapped around each leg. The three legs are typically manufactured as separate pieces that are bonded together after the coil windings have been wrapped around each leg. The process for making such cores is typically expensive and results in inaccurate bonding joints. The air gap between the legs is typically small (e.g., 0.5 millimeters (mm)). Because of the small air gap, the core develops a high induction, so that the core becomes saturated at magnetic fields under 40 milli-Tesla (mT). Prior cores have also typically been made from a ferrite material, which tends to be brittle, not very durable, and has a large hysteresis.

### SUMMARY

One embodiment provides a magnetic core for testing a magnetic sensor. The magnetic core includes a base portion, and first, second, and third legs extending from the base portion. At least one coil generates magnetic flux through the magnetic core and into the magnetic sensor. The base portion and the first, second, and third legs are formed as a single piece without bonding joints therebetween.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is diagram illustrating a prior art speed sensor for sensing the speed of a magnetic tooth wheel.

FIG. 2 is a diagram illustrating a side view of a magnetic core for testing a magnetic sensor according to one embodiment.

FIG. 3 is a diagram illustrating the magnetic core shown in FIG. 2 including dimensions of the core according to one embodiment.

FIG. 4 is a diagram illustrating a cross-sectional view of the magnetic core shown in FIG. 2 with coil windings wrapped around the outer legs of the core according to one embodiment.

FIG. 5 is a diagram illustrating a cross-sectional view of the magnetic core shown in FIG. 2 with coil windings, protective elements, and a cooling element, according to one embodiment.

FIG. 6A is a diagram illustrating a cross-sectional view of a magnetic sensor suitable to be tested by the magnetic core according to one embodiment.

FIG. 6B is a diagram illustrating a top view of the magnetic sensor shown in FIG. 6A according to one embodiment.

FIG. 7 is a diagram illustrating magnetic flux generated by the magnetic core shown in FIG. 5 according to one embodiment.

FIG. 8 is a diagram illustrating magnetic flux generated by the magnetic core shown in FIG. 5 according to another embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

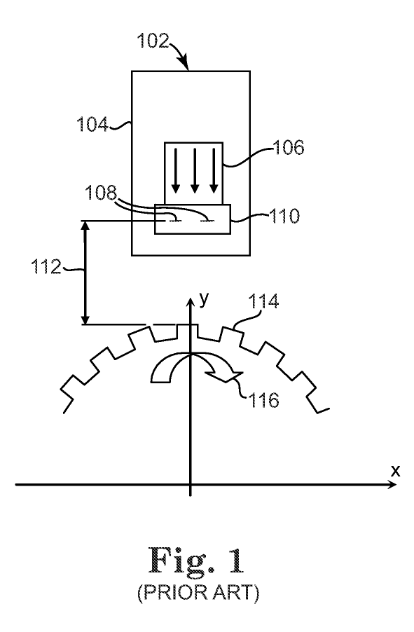

FIG. 1 is diagram illustrating a prior art speed sensor 102 for sensing the speed of a magnetic tooth wheel 114. The speed sensor 102 includes a permanent magnet 106 and a magnetic sensor integrated circuit 110 surrounded by a protective cover 104. The magnetic sensor integrated circuit 110 includes a plurality of magnetic sensor elements 108, such as Hall sensor elements or xMR sensor elements (e.g., GMR—giant magneto resistance; AMR—anisotropic magneto resistance; TMR—tunnel magneto resistance; CMR—colossal magneto resistance). The permanent magnet 106 provides a bias magnetic field to the sensor elements 108. In the illustrated embodiment, the bias magnetic field is perpendicular to the plane of the integrated circuit 110 (e.g., in the Y-direction). The sensor elements 108 are separated from the magnetic tooth wheel 114 by an air gap distance 112. As the wheel 114 is rotated in the direction shown by arrow 116, the teeth of the wheel 114 pass in front of the sensor 102 and generate a small field variation, which is detected by the integrated circuit 110. The detected field contains information about the angular position and rotational speed of the wheel 114. The waveform of the field is nearly sinusoidal and its amplitude decreases drastically with the air gap 112.

It is desirable to be able to test magnetic sensors, such as sensor 102, to help ensure that the sensors are operating correctly properly. One method for testing a magnetic sensor is to use a magnetic core to apply test magnetic fields to the sensor, and measure the sensor response.

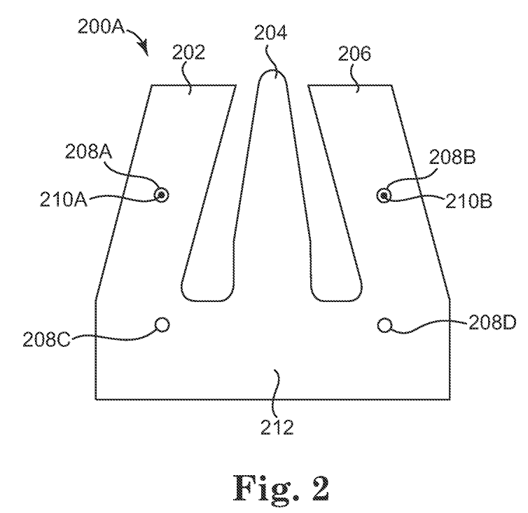

FIG. 2 is a diagram illustrating a side view of a magnetic core 200A for testing a magnetic sensor according to one embodiment. As shown in FIG. 2, magnetic core 200A includes a base portion 212, and three legs 202, 204, and 206 that extend upward from the base portion. In the illustrated embodiment, the outer legs 202 and 206 each have a substantially uniform cross-sectional area along the length of the legs 202 and 206, and the middle leg 204 has a cross-sectional area that varies along the length of the leg 204. The cross-sectional area of the middle leg 204 increases from a minimum area near the tip of the leg 204 to a maximum area near the base portion 212. In one embodiment, the middle leg 204 has a substantially conical shape.

A plurality of holes 208A-208D are formed in the magnetic core 200A. In one embodiment, one or more of the holes 208A-208D are configured to receive a temperature sensor for measuring the temperature within the core 200A during testing of a magnetic sensor. In the illustrated embodiment, temperature sensors 210A and 210B are placed within holes 208A and 208B, respectively. The holes 208A and 208B are positioned near the center of the outer legs 202 and 206, respectively, where the temperature is typically at a maximum. In one embodiment, holes 208C and 208D are used for attaching or mounting the core 200A.

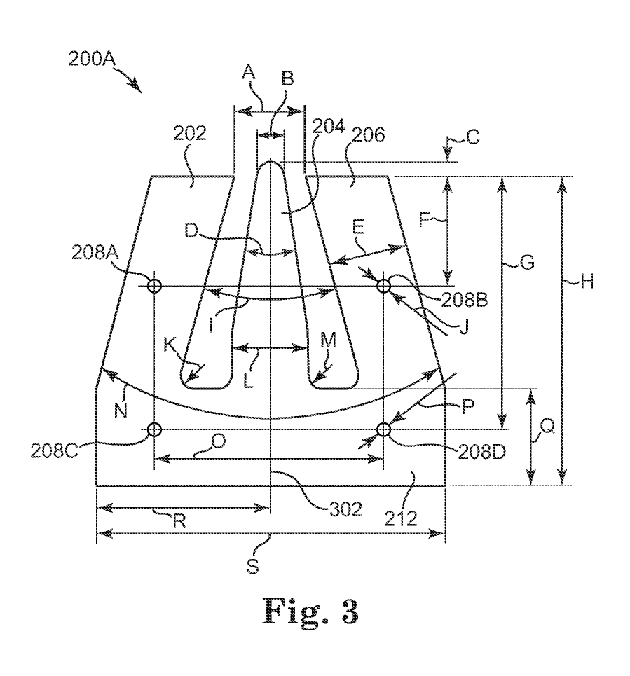

FIG. 3 is a diagram illustrating the magnetic core 200A shown in FIG. 2 including dimensions of the core according to one embodiment. Magnetic core 200A is symmetric about symmetry line 302. The dimensions of the core 200A according to one embodiment are as follows:

A = 4 mm
B = 0.5 mm
C = 0.25 mm
D = 25°
E = 8 mm
F = 10 mm
G = 24 mm
H = 30 mm
I = 30°
J = 1.7 mm
K = 1 mm (radius)
L = 8 mm
M = 1 mm (radius)
N = 30°
O = 17 mm
P = 1.7 mm
Q = 8.8 mm
R = 15.9 mm
S = 31.8 mm

As given above, dimension A according to one specific embodiment is 4 mm. In another embodiment, the range of values for the magnitude of dimension A is determined from the following Equation I:

A=1.0*d to 2.2*d Equation I
Where:
   d=the distance between left and right sensor elements in a magnetic sensor to be tested.

In one embodiment, the distance, d, is 2.5 mm. Thus, dimension A according to one embodiment is in the range of 2.5 to 5.5 mm. Dimension B according to one specific embodiment is 0.5 mm. In another embodiment, dimension B is less than or equal to 1.0 mm. The relatively narrow tip of the center leg 204 helps to guide magnetic flux to a center sensor element of a magnetic sensor being tested. The broadening of the center leg 204 going downwards towards the base portion 212 helps to prevent the core 200A from going into saturation. As indicated above, dimension C according to one specific embodiment, is 0.25 mm. In another embodiment, dimension C is zero (i.e., the tip of the central leg 204 is flush with the tips of the outer legs 202 and 206). It will be understood that the other dimensions given above may also vary from the specific numbers set forth above.

In one embodiment, magnetic core 200A is 18 mm thick (i.e., in a direction into the paper), and is formed from 90 laminated sheets of low coercivity sheet metal, with each sheet being 0.2 mm thick. The use of low coercivity or soft magnetic material for the magnetic core 200A helps to keep the hysteresis of the core 200A small. In another embodiment, the sheets are each less than or equal to 0.3 mm thick, and the thickness of the magnetic core 200A is 5 to 20 mm thick. Each sheet is etched into the pattern shown in FIG. 3, thereby forming a plurality of etched sheets or magnetic core layers. Each etched sheet or magnetic core layer includes three legs and a base portion. The magnetic core layers are aligned, and attached together in a stack via an adhesive layer positioned between each magnetic core layer. In one embodiment, the surfaces of the magnetic core layers are oxidized prior to attachment to form an isolating layer between each magnetic core layer.

The use of laminated sheet metal for core 200A results in a more durable core than prior cores made of ferrite material, and helps to prevent the core from being damaged by thermal stresses and mechanical loads. In one embodiment, core 200A is made from sheets of Mumetal®. In another embodiment, core 200A is made from sheets of Vitrovac®.

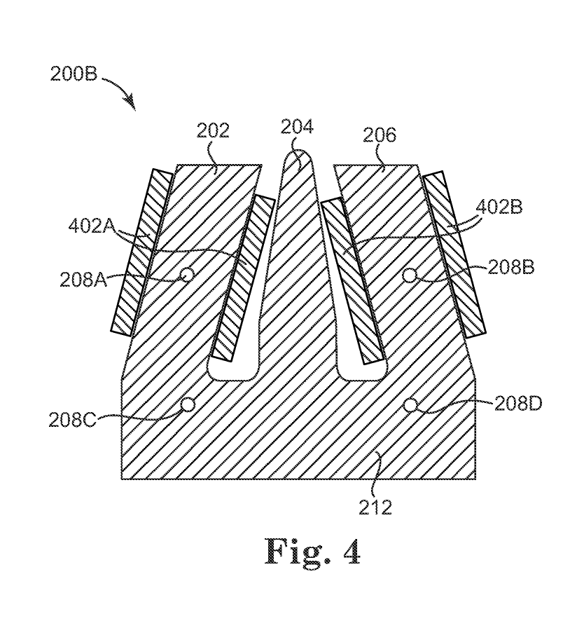

FIG. 4 is a diagram illustrating a cross-sectional view of the magnetic core shown in FIG. 2 with coil windings 402A and 402B wrapped around the outer legs 202 and 206 of the core according to one embodiment. In one embodiment, the coil windings 402A and 402B are pre-formed by a coil former (i.e., pre-wound or pre-formed into a freestanding coil prior to being placed around the outer legs 202 and 206). The pre-formed coil windings 402A and 402B are then slid over the top of the outer legs 202 and 206 of the core 200A, and adhesively attached to the legs 202 and 206, thereby forming the core 200B shown in FIG. 4.

Prior magnetic cores have used outer legs that are bent towards each other at a ninety degree angle, such that the tips of the outer legs face each other. For such cores, it is not possible to slide pre-formed coil windings onto the outer legs. Rather, as discussed in the Background section, the coils are first wrapped around the legs, and then the legs are bonded together. In contrast, the outer legs 202 and 206 of the one-piece core 200B shown in FIG. 4 are angled inward at an angle of about fifteen degrees in one embodiment, and pre-formed coils may be slid over the top of the outer legs 202 and 206. The outer legs 202 and 206 of the one-piece core 200B shown in FIG. 4 are angled inward at an angle of less than about forty-five degrees in one embodiment.

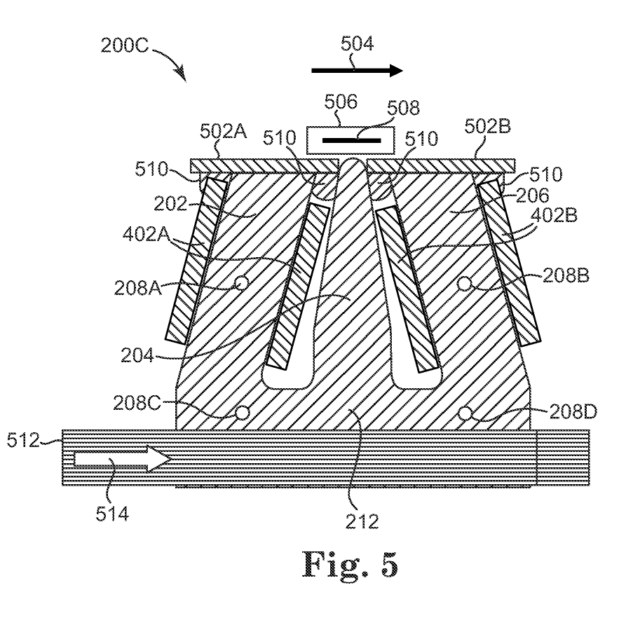

FIG. 5 is a diagram illustrating a cross-sectional view of the magnetic core shown in FIG. 2 with coil windings 402A and 402B, protective elements 502A and 502B, and a cooling element 512, according to one embodiment. The addition of these elements to core 200A results in the magnetic core 200C shown in FIG. 5. The protective elements 502A and 502B are placed over the top of the outer legs 202 and 206, and are held in place by adhesive (e.g., glue) 510. In one embodiment, protective elements 502A and 502B are glass or ceramic plates that are about 0.25 mm thick. In another embodiment, protective elements 502A and 502B are plates of Torlon®. Since the end or tip of middle leg 204 extends higher than the ends of outer legs 202 and 206 by about 0.25 mm in one embodiment, the top of the protective elements 502A and 502B are about even or flush with the top of the middle leg 204. The protective elements 502A and 502B protect the top surface of the laminated core 200C from abrasion and help to avoid electrical short circuits when pins of the device under test touch the laminated metal sheets of the core 200C.

In one embodiment, cooling element 512 is a U-shaped pipe with a rectangular cross section that is wound around the bottom of the core 200C. A cooling liquid, such as a thermo-oil, is pumped through the cooling element 512 to provide cooling of the core 200C during testing. The cooling liquid flows in the direction indicated by arrow 514 at the front of the core 200C, and flows in the opposite direction at the back of the core 200C.

In one embodiment, magnetic core 200C is configured to provide a magnetic field amplitude of between about 0 to 70 mT (milli-Tesla), with hysteresis of less than 30 μT (micro-Tesla), and is capable of producing maximum frequencies of 15 kHz. In one embodiment, magnetic core 200C is configured to be operated in an ambient temperature range of −40° C. to +150° C.

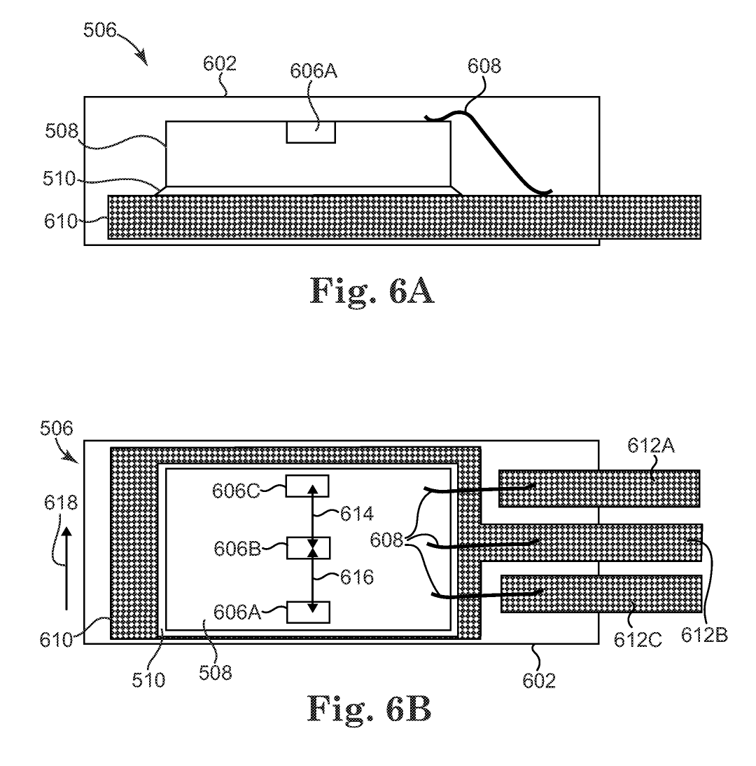

FIG. 5 also shows a magnetic sensor 506 to be tested using the magnetic core 200C. The magnetic sensor 506 includes a magnetic sensor integrated circuit 508. During testing, the magnetic sensor 506 is moved in the direction indicated by arrow 504 (i.e., the magnetic sensor 506 is slid laterally across the top surface of the core 200C). One embodiment of a magnetic speed sensor 506 suitable to be tested using magnetic core 200C is described in further detail below with reference to FIGS. 6A and 6B.

FIG. 6A is a diagram illustrating a cross-sectional view of a magnetic sensor 506 suitable to be tested by the magnetic core 200C according to one embodiment. FIG. 6B is a diagram illustrating a top view of the magnetic sensor 506 shown in FIG. 6A according to one embodiment. Magnetic sensor 506 includes a protective cover (e.g., mold compound) 602, magnetic sensor integrated circuit (e.g., silicon die) 508, die attach layer 510, lead frame 610, bond wires 608, and leads 612A-612C. Integrated circuit 508 is attached to lead frame 610 via die attach layer 510. Integrated circuit 508 includes a plurality of magnetic sensor elements 606A-606C, such as Hall sensor elements or xMR sensor elements (e.g., GMR—giant magneto resistance; AMR—anisotropic magneto resistance; TMR—tunnel magneto resistance; CMR—colossal magneto resistance). The integrated circuit 508 is electrically connected to the leads 612A-612C via the bond wires 608. The protective cover 602 surrounds and protects the integrated circuit 508.

In the illustrated embodiment, the integrated circuit 508 includes three sensor elements 606A-606C. Sensor element 606B is separated from sensor element 606C by a distance 614, and sensor element 606B is separate from sensor element 606A by a distance 616. In one embodiment, distances 614 and 616 are each 1.25 mm. In another embodiment, integrated circuit 508 includes two sensor elements (e.g., the integrated circuit 508 does not include the center sensor element 608B). The center sensor element 608B is used for direction detection, and is not used in a speed sensor if direction detection is not desired.

During testing, magnetic sensor 506 is moved adjacent to the top surface of magnetic core 200C in the direction indicated by arrow 618. Sensor signals generated by the integrated circuit 508 during testing are output through the bond wires 608 and leads 612A-612C to test equipment to monitor the operation of the integrated circuit 508.

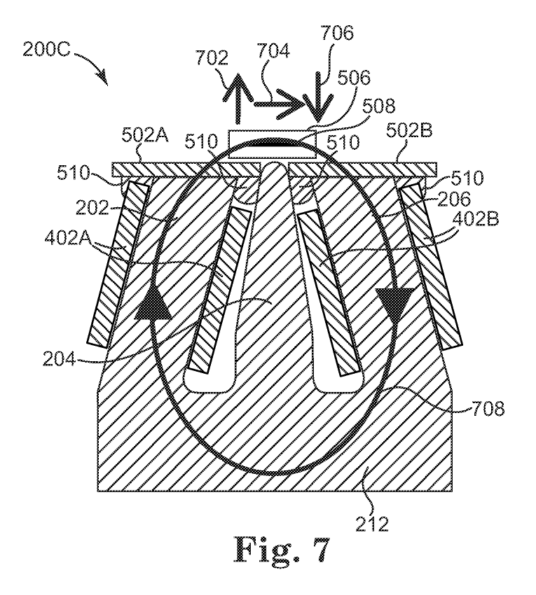

FIG. 7 is a diagram illustrating magnetic flux 708 generated by the magnetic core 200C shown in FIG. 5 (with the holes 208A-208D and cooling element 512 removed) according to one embodiment. The magnetic flux 708 is generated by providing a current through the coils 402A and 402B. A current is defined herein as positive if it produces a magnetic flux that is pointed towards the magnetic sensor 506 (i.e., upwards in FIG. 7), and a current is defined as negative if it produces a magnetic flux that is pointed away from the magnetic sensor 506 (i.e., downwards in FIG. 7). In the embodiment shown in FIG. 7, the current through coil 402A is positive and the current through coil 402B is negative. This is referred to as an I+− mode. The I+− mode results in an upwards flux through the left leg 202, zero flux through the center leg 204, and a downwards flux through the right leg 206.

The magnetic flux applied to the magnetic sensor 506 in the I+− mode is as follows: (1) upwards on the left sensor element 606A (FIG. 6B), as represented by arrow 702; (2) horizontal on the center sensor element 606B (FIG. 6B), as represented by arrow 704; and (3) downwards on the right sensor element 606C (FIG. 6B), as represented by arrow 706. The magnetic field produced in the I+− mode may be used for a couple of purposes. For a magnetic sensor 506 that uses Hall sensor elements, the I+− mode produces a differential field on the left and right sensor elements 606A and 606C. The difference between the left and right sensor element 606A and 606C is large compared to zero. This type of magnetic field is referred to as a Hall speed field. For a magnetic sensor 506 that uses xMR sensor elements, the I+− mode produces a horizontal magnetic field on the center sensor element 606B. This type of magnetic field is referred to as an xMR direction field.

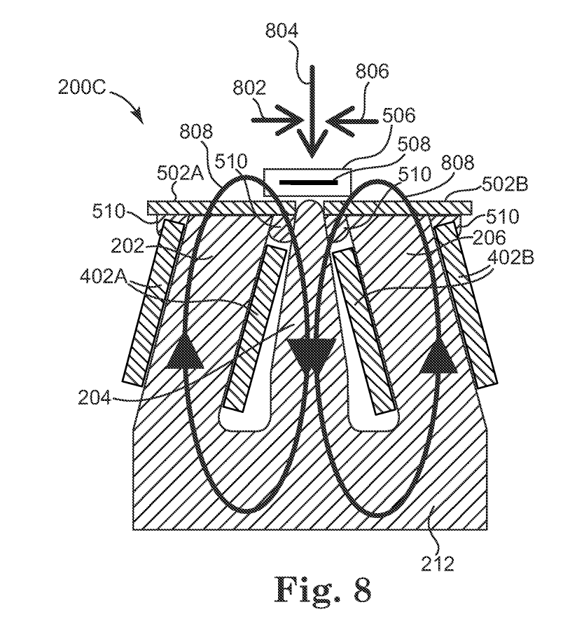

FIG. 8 is a diagram illustrating magnetic flux 808 generated by the magnetic core 200C shown in FIG. 5 (with the holes 208A-208D and cooling element 512 removed) according to another embodiment. In the embodiment shown in FIG. 8, the current through coil 402A is positive and the current through coil 402B is also positive. This is referred to as an I++ mode. The I++ mode results in an upwards flux through the left leg 202, a downwards flux through the center leg 204, and an upwards flux through the right leg 206.

The I++ mode results in maximum flux through the center leg 204, and the magnetic flux applied to the magnetic sensor 506 in the I++ mode is as follows: (1) rightwards on the left sensor element 606A (FIG. 6B), as represented by arrow 802; (2) downwards on the center sensor element 606B (FIG. 6B), as represented by arrow 804; and (3) leftwards on the right sensor element 606C (FIG. 6B), as represented by arrow 806. The magnetic field produced in the I++ mode may be used for a couple of purposes. For a magnetic sensor 506 that uses xMR sensor elements, the I++ mode produces a differential field on the left and right sensor elements 606A and 606C. The difference between the left and right sensor element 606A and 606C is large compared to zero. This type of magnetic field is referred to as an xMR speed field. For a magnetic sensor 506 that uses Hall sensor elements, the I++ mode produces a vertical magnetic field on the center sensor element 606B. This type of magnetic field is referred to as a Hall direction field. In another embodiment, the magnetic field shown in FIG. 8 is generated by providing a coil winding around the center leg 204 and providing a negative current in the coil.

Referring again to FIG. 3, the air gap (i.e., the distance between the left leg 202 and the center leg 204, or the distance between the right leg 206 and the center leg 204) is 1.75 mm in one embodiment (i.e., (4−0.5)/2). If the air gap of a magnetic core is modified, and one observes the field inaccuracies that result from small position changes of the device under test, the following results are observed. For xMR speed fields, the errors are maximum for air gaps around 1.1 mm. The errors decrease for larger and smaller air gaps. For Hall speed fields, the errors are minimum for air gaps around 1.7 mm. The errors increase for larger and smaller air gaps. Thus, the magnetic core according to one embodiment provides very low errors for both Hall sensors and xMR sensors, and therefore, may be considered a “universal” core that may be used to test multiple types of sensors.

In addition to being able to test multiple types of sensors, the magnetic core according to one embodiment also provides other advantages over prior magnetic cores. The magnetic core according to one embodiment is a single-piece core in which the individual legs of the core are formed as a single unit, rather than being formed separately and bonded together. The single-piece magnetic core according to one embodiment is less expensive to manufacture than prior multi-piece cores, and does not suffer from the inaccurate bonding joint problems of prior cores. The air gap between the legs of the magnetic core according to one embodiment is larger than prior magnetic cores, which results in the core developing a lower induction than prior cores, and the core is able to generate higher magnitude magnetic fields without becoming saturated. The magnetic core according to one embodiment is made of a soft (e.g., low coercivity) magnetic material, and the core is more durable and has a smaller hysteresis than prior cores made of a ferrite material.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A magnetic core for testing a magnetic sensor, comprising:
a base portion;
first, second, and third legs extending from the base portion;
at least one coil for generating magnetic flux through the magnetic core and into the magnetic sensor; and
wherein the base portion and the first, second, and third legs are formed as a single piece without bonding joints therebetween.

2. The magnetic core of claim 1, wherein the magnetic core is formed from Mumetal®.

3. The magnetic core of claim 1, wherein the magnetic core is formed from Vitrovac®.

4. The magnetic core of claim 1, wherein the magnetic core is formed from stacked metal sheets.

5. The magnetic core of claim 4, wherein the metal sheets are less than about 3 mm thick.

6. The magnetic core of claim 5, wherein the magnetic core has a thickness of between about 5 mm and 20 mm.

7. The magnetic core of claim 1, wherein the first and third legs are outer legs, and the second leg is a middle leg positioned between the two outer legs, wherein the first and third legs each have a substantially uniform cross-sectional area along a length of the leg, and wherein the second leg has a cross-sectional area that increases going from a tip of the leg toward the base portion.

8. The magnetic core of claim 7, wherein the tip of the second leg has a width of less than about 1.0 mm.

9. The magnetic core of claim 7, wherein the first and the third legs are each angled toward the second leg at an angle of less than about 45 degrees.

10. The magnetic core of claim 7, wherein ends of the first and the third legs are separated from each other by a distance of between about 2.5 mm and 5.5 mm.

11. The magnetic core of claim 7, wherein the second leg extends higher than the first and the third legs.

12. The magnetic core of claim 11, wherein the second leg extends higher than the first and the third legs by a distance of about 0.25 mm.

13. The magnetic core of claim 1, and further comprising at least one protective plate formed over ends of the first and third legs.

14. The magnetic core of claim 1, wherein the magnetic core has at least one hole formed therein.

15. The magnetic core of claim 14, and further comprising at least one temperature sensor positioned in the at least one hole.

16. The magnetic core of claim 1, and further comprising a cooling pipe surrounding the base portion.

17. The magnetic core of claim 16, wherein the cooling pipe is configured to receive a cooling liquid that flows through the cooling pipe to cool the magnetic core.

18. The magnetic core of claim 1, wherein the magnetic core is configured to test both Hall magnetic sensors and GMR magnetic sensors.

19. A method of making a magnetic core, comprising:
providing a plurality of metal sheets;
etching the plurality of metal sheets to form a corresponding plurality of magnetic core layers, each magnetic core layer having three legs; and
attaching the magnetic core layers together in a stack.

20. The method of claim 19, and further comprising:
sliding at least one pre-formed coil winding over at least one of the legs and attaching the coil winding thereto.

21. A magnetic core for testing a magnetic sensor, comprising:
a plurality of metal layers attached together in a stack, each metal layer including first, second, and third legs extending from a base portion; and
at least one coil wrapped around at least one of the legs for generating magnetic flux through the magnetic core and into the magnetic sensor.

22. The magnetic core of claim 21, wherein the metal layers are less than about 3 mm thick.

23. The magnetic core of claim 21, wherein the metal layers are layers of one of Mumetal® or Vitrovac®.

24. The magnetic core of claim 21, wherein the first and third legs are outer legs, and the second leg is a middle leg positioned between the two outer legs, wherein the first and third legs each have a substantially uniform cross-sectional area along a length of the leg, and wherein the second leg has a cross-sectional area that increases going from a tip of the leg toward the base portion.

25. The magnetic core of claim 24, wherein the first and the third legs are each angled toward the second leg at an angle of less than about 45 degrees.
